(19) United States
(12) Patent Application Publication
(10) Pub. No.: US 2025/0212868 A1
(43) Pub. Date: Jul. 3, 2025

(54) SYSTEMS AND METHODS FOR SPRAYING AN AGRICULTURAL FLUID ON FOLIAGE

(71) Applicant: Capstan Ag Systems, Inc., Topeka, KS (US)

(72) Inventors: Wyatt Kerl, Hiawatha, KS (US); Jeffrey John Grimm, Holton, KS (US)

(21) Appl. No.: 18/989,788

(22) Filed: Dec. 20, 2024

Related U.S. Application Data
(60) Provisional application No. 63/616,701, filed on Dec. 31, 2023.

(51) Int. Cl. A01M 7/00

(52) U.S. Cl. CPC A01M 7/0089

(57) ABSTRACT

A system for applying agricultural fluid to a target includes a fluid supply line, a plurality of nozzle assemblies, and a plurality of electrically actuated valve assemblies. The system includes a user interface configured to receive a user input relating to a user selection of an alternative operation mode, and a controller communicatively connected to the valve assemblies and configured to control at least one operating parameter of the plurality of electrically actuated valve assemblies. The controller is configured to retrieve a first flow value, determine the at least one operating parameter based on the first flow value, receive a signal from the user interface relating to the user selection of the alternative operation mode, retrieve a second flow value, and determine the at least one operating parameter based on the second flow value in response to the user selecting the alternative operation mode.

### CROSS-REFERENCE TO RELATED APPLICATIONS

This application claims the benefit of priority to U.S. Provisional Patent Application No. 63/616,701, filed Dec. 31, 2023, the entire contents of which are hereby incorporated by reference herein.

### BACKGROUND

The present disclosure relates generally to fluid application systems, and particularly, to systems for spraying an agricultural fluid on foliage.

In the agricultural industry, agricultural fluids or agrochemicals are commonly applied to plants for a variety of reasons. For example, liquid fertilizers, pesticides, and other agrochemicals may be applied to plants or crops after planting for crop management. Agricultural fluids include, without limitation, growth promotors, growth regulators, spray fertilizers, pesticides, insecticides, and/or fungicides.

For example, agricultural fluids may be applied to the foliage of plants in groves or orchards. The groves or orchards may include plants such as vines and trees that have an uneven distribution of foliage. On some plants, the foliage may be concentrated anywhere along the height of the plant. For example, the foliage may be concentrated at the top of the plant and may be relatively sparse at the base of the plant. In addition, the plants may be different sizes and may be shaped irregularly. Moreover, the groves or orchards may include portions with little or no foliage due to, for example, plants that have been damaged or destroyed due to hurricanes or other weather events. Accordingly, it may be difficult to apply the fluid throughout the foliage in an even manner.

Typically, systems for applying agricultural fluids to foliage include a fluid supply line (e.g., a manifold or boom pipe), and a plurality of nozzle assemblies that receive fluid from the fluid supply line for applying the fluid to a field. The systems may also include a fan or blower to provide airflow that carries the agricultural fluid towards the foliage. In prior systems, the spray tip or orifice of each of the nozzle assemblies was selected based on variations in the foliage to which the fluid was being applied. Spray tips or orifices were selected based on the foliage density, the desired application rate, and the current configuration of the nozzle assemblies relative to the foliage. However, calculations needed to determine appropriate spray tips or orifices are often difficult to perform accurately in the field. Accordingly, operators may be prone to estimate or guess at least some of the factors for determining proper nozzle adjustment. Errors made in the calculations and/or inaccurate estimates may reduce the effectiveness of the adjustments and may even exacerbate the inefficiencies of the spray process. Moreover, manually interchanging spray tips or orifices on each nozzle assembly to produce a desired spray pattern or characteristic increases the time required to perform a spraying operation.

At least some known systems include sensors that detect foliage to allow the system to be controlled based on the detected foliage. However, such systems can only control the system based on a range of operating conditions for groups of nozzle assemblies and may not be able to adjust the nozzle assemblies to accommodate variations in foliation or other parameters such as speed. As a result, such systems may under spray and/or overspray the foliage and/or spray gaps in foliage even when utilizing the sensors. In addition, the systems may increase the time required to spray the foliage because the controller performs calculations based on the sensor readings during operation of the system.

Typically, systems for applying agricultural fluids to foliage do not utilize information relating to a speed of the system to vary operating parameters and instead rely on a user to maintain a constant speed when spraying the foliage. However, the user may not always maintain a constant speed and, thereby the systems may under spray and/or overspray the foliage.

Accordingly, a foliage spray system that is capable of determining and/or adjusting operating parameters based on a reliable speed value and/or a user selected operation mode is particularly useful.

### BRIEF SUMMARY

In one aspect, a system for applying agricultural fluid to a target includes a fluid supply line connected to a fluid supply and a plurality of nozzle assemblies connected in fluid communication with the fluid supply line. The nozzle assemblies are positioned and oriented to spray the target. The system also includes a plurality of electrically actuated valve assemblies. Each valve assembly of the plurality of electrically actuated valve assemblies is connected in fluid communication between the fluid supply line and a corresponding one of the plurality of nozzle assemblies to control fluid flow through the respective nozzle assembly. The system includes a user interface configured to receive a user input relating to a user selection of an alternative operation mode, and a controller communicatively connected to the valve assemblies and configured to control at least one operating parameter of the plurality of electrically actuated valve assemblies. The controller is configured to retrieve a first flow value, determine the at least one operating parameter based on the first flow value, receive a signal from the user interface relating to the user selection of the alternative operation mode, retrieve a second flow value, and determine the at least one operating parameter based on the second flow value in response to the user selecting the alternative operation mode.

In another aspect, a method of applying agricultural fluid to a target includes positioning a spray apparatus within a field including the target. The spray apparatus includes a fluid supply line, and a plurality of nozzle assemblies connected in fluid communication with the fluid supply line. The nozzle assemblies are positioned and oriented to spray the target. The spray apparatus also includes a plurality of electrically actuated valve assemblies. Each valve assembly of the plurality of electrically actuated valve assemblies is connected in fluid communication between the fluid supply line and a corresponding one of the plurality of nozzle assemblies to control fluid flow through the respective nozzle assembly. A controller is communicatively connected to the valve assemblies and configured to control at least one operating parameter of the plurality of electrically actuated valve assemblies. The method includes retrieving, using the controller, a first flow value; determining the at least one operating parameter of the plurality of valve assemblies based on the first flow value; and receiving a user input relating to a user selection of an alternative operation mode. The method further includes retrieving, using the controller, a second flow value, and determining the at least one operating parameter of the plurality of valve assemblies based on the second flow value in response to the user selecting the alternative operation mode.

In yet another aspect, a system for applying agricultural fluid to a target as the system moves relative to the target includes a fluid supply line connected to a fluid supply and a plurality of nozzle assemblies connected in fluid communication with the fluid supply line. The nozzle assemblies are positioned and oriented to spray the target. The system also includes a plurality of electrically actuated valve assemblies. Each valve assembly of the plurality of electrically actuated valve assemblies is connected in fluid communication between the fluid supply line and a corresponding one of the plurality of nozzle assemblies to control fluid flow through the respective nozzle assembly. The system further includes a global positioning system (GPS) receiver configured to receive a GPS signal from at least one GPS satellite. The GPS signal includes a speed component relating to a speed of the system. The system includes a controller communicatively connected to the plurality of electrically actuated valve assemblies and the GPS receiver. The controller is configured to control at least one operating parameter of the plurality of electrically actuated valve assemblies. The controller is configured to filter the GPS signal to identify the speed component, determine a ground speed of the system based on the speed component of the GPS signal, determine the at least one operating parameter of the plurality of electrically actuated valve assemblies based on the determined ground speed if the determined ground speed of the system is within a predetermined range, and determine the at least one operating parameter of the plurality of electrically actuated valve assemblies based on a preset value if the determined ground speed of the system is outside the predetermined range.

In a further aspect, a system for applying agricultural fluid to a target includes a fluid supply line connected to a fluid supply and a plurality of nozzle assemblies connected in fluid communication with the fluid supply line. The nozzle assemblies are positioned and oriented to spray the target. The system also includes a plurality of electrically actuated valve assemblies. Each valve assembly of the plurality of electrically actuated valve assemblies is connected in fluid communication between the fluid supply line and a corresponding one of the plurality of nozzle assemblies to control fluid flow through the respective nozzle assembly. The system includes one or more sensors, and a controller communicatively connected to the one or more sensors and to the valve assemblies and configured to control at least one operating parameter of the plurality of electrically actuated valve assemblies. The controller is configured to retrieve a first flow value and a second flow value, determine the at least one operating parameter based on the first flow value, receive a signal from one or more sensors related to the alternative operation mode, select the alternative operation mode based on the signal, and determine the at least one operating parameter based on the second flow value.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a schematic view of an example fluid application system for spraying foliage;

FIG. 2 is an image of an example graphical user interface of a portable electronic device for use with the fluid application system; and

FIG. 3 is a flow diagram of an example method of applying agricultural fluid to foliage.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

Systems and methods disclosed herein facilitate application of agricultural fluids to plants, particularly in orchards or groves. For example, embodiments of the systems and methods facilitate dispensing fluid towards foliage of a plant according to a relative amount or density of the foliage based on user inputs. Particular embodiments of the systems and methods disclosed herein enable a user to select an alternative operation mode (e.g., nozzles are not all open) when a gap or variation in the foliage occurs as the fluid application system travels through the grove or orchard. The user may select the alternative operation mode for a select number of nozzles or for all nozzles. When the gap or variation ends, the user may return the system to the default operation mode for the select number of nozzles or for all nozzles. A controller of the system may control operation of the nozzles in response to user inputs or selections.

In addition, embodiments of the disclosure facilitate a controller of the system operating valve assemblies based on a speed of the system. For example, the controller receives and processes a global positioning system (GPS) signal to determine an average moving speed and determines one or more operating parameters of the valve assemblies based on the average moving speed. Particular embodiments of the systems and methods disclosed herein provide a low cost and reliable means for controlling the spray from the fluid application system based on a rate of travel. As a result, the embodiments facilitate improved application of fluid onto the foliage.

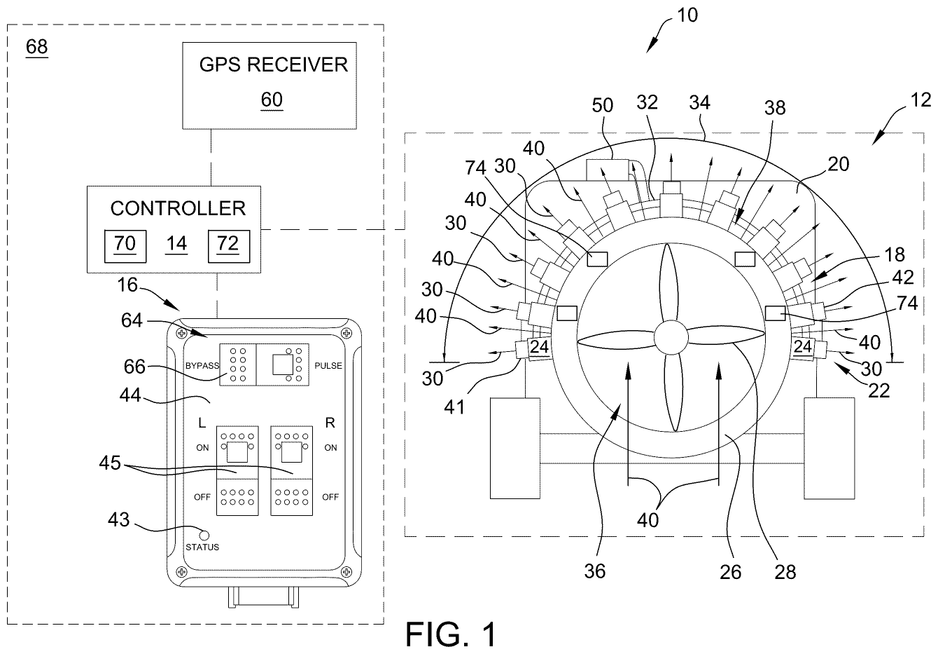

FIG. 1 is a schematic view of an example fluid application system, designated in its entirety by the reference number 10. In the example embodiment, fluid application system 10 includes a spray apparatus 12, illustrated from an end view of FIG. 1, a controller 14, and a user input device 16. Unless otherwise noted, directions, such as horizontal and vertical, refer to the orientation of the fluid application system 10 shown in FIG. 1.

Spray apparatus 12 includes a manifold 18, a fluid supply or reservoir 20, a plurality of nozzle assemblies 22, a plurality of valve assemblies 24, a frame 26, and a fan or blower 28. Spray apparatus 12 is supported on a chassis including a plurality of wheels that allow spray apparatus 12 to be moved along the ground. Spray apparatus 12 may be coupled to a vehicle (not shown) configured to move spray apparatus 12 along the ground. Spray apparatus 12 may receive mechanical and/or electrical power from the vehicle and/or may have its own power source, such as an engine. In further embodiments, spray apparatus 12 may be self-propelled and/or configured to operate at a fixed location.

In the example embodiment, spray apparatus 12 is an air blast sprayer in which fluid emitted from nozzle assemblies 22 is propelled by airflow generated by fan 28. Accordingly, fluid application system 10 may be used as an agricultural sprayer, e.g., an orchard sprayer, for spraying crops. Such crops may define a canopy at a distance above the ground. In other embodiments, spray apparatus 12 may have any configuration suitable for spraying fluid onto plants. For example, in some embodiments, spray apparatus 12 may be configured as, without limitation, an air blast sprayer, an herbicide sprayer, a vineyard sprayer, an over-the-row boom sprayer, a fan sprayer, a vertical or tower sprayer, and a small batch sprayer.

Further, in the example embodiment, fluid reservoir 20 holds a quantity of material 30, such as, and without limitation, a liquid, a mixture of liquid and powder, and/or other material, to be dispensed by fluid application system 10, for example, onto a crop. In some embodiments, material 30 may be water or an agrochemical such as an herbicide or a pesticide, and may be dispensed by nozzle assemblies 22 onto, for example, the crop and/or the ground. The quantity of material 30 held in fluid reservoir 20 generally flows through manifold 18 to nozzle assemblies 22. For example, a pump assembly 50 may be configured to selectively draw a flow of material 30 from reservoir 20 through an inlet conduit and pressurize the flow of material 30. The terms “pipe” and “conduit,” as used herein, include any type of tube made of any suitable material such as metal, rubber, or plastic, for channeling material 30 therethrough.

Manifold 18 includes a fluid supply line or pipe 32 connected to fluid reservoir 20 and supported by frame 26. Manifold 18 has a length 34, and nozzle assemblies 22 are positioned along length 34 of manifold 18. In the example, manifold 18 is curved, and nozzle assemblies 22 are spaced circumferentially along manifold 18. In the example, nozzle assemblies 22 are evenly spaced along manifold 18. Nozzle assemblies 22 are positioned on manifold 18 such that fluid (e.g., material 30) emitted from nozzle assemblies 22 is directed radially outward from spray apparatus 12. In other embodiments, spray apparatus 12 may include any manifold 18 that enables spray apparatus 12 to operate as described. In yet other embodiments, nozzle assemblies 22 may be mounted to frame 26 at suitable locations and orientations to produce a desired spray pattern. In such embodiments, nozzle assemblies 22 may be connected to manifold 18 by suitable flow conduits, such as hoses or pipes.

In the example embodiment, frame 26 is cylindrical and extends about fan 28. In addition, frame 26 defines a central inlet 36 and at least one outlet 38 extending circumferentially about fan 28. Fan 28 is configured to rotate and, thereby generate an airstream 40. Specifically, airstream 40 is drawn into inlet 36 and redirected radially outward from fan 28 through outlet 38. Nozzle assemblies 22 are positioned proximate outlet 38 within the path of airstream 40. Accordingly, fluid (e. g., material 30) emitted from nozzle assemblies 22 is carried by airstream 40. Notably, the direction and orientation of nozzle assemblies 22 relative to the direction of airstream 40 affects the fluid flow characteristics of fluid carried by airstream 40. Nozzle assemblies 22 may be operated to provide desired fluid flow characteristics based on the orientation and position of nozzle assemblies 22. For example, fluid application system 10 may facilitate control of characteristics of the fluid, e.g., pressure, flow rate, and droplet size, based on the orientation and position of nozzle assemblies 22. Additionally, fluid application system 10 may facilitate control of characteristics of airflow 40, e.g., flow rate. As a result, fluid application system 10 may facilitate providing desired application rates to the crops adjacent the ground and in the canopy.

In the example embodiment, each nozzle assembly 22 includes a nozzle body 41 and a spray nozzle 42. Spray nozzle 42 may have any suitable nozzle configuration known in the art, for example, and without limitation, spray nozzle 42 may include a spray tip (not shown), such as a flat fan tip, cone tip, straight stream tip and/or any other suitable spray tip that enables nozzle assembly 22 to function as described herein.

Similarly, valve assembly 24 may generally have any suitable valve configuration known in the art, for example, and without limitation, a latching solenoid valve, 2WNC solenoid valve, pilot actuated solenoid valve, flipper solenoid valve, and/or the like. In the example embodiment, valve assembly 24 is a direct acting solenoid valve that includes an actuator configured to pulse with a timing, duration, frequency, and duty cycle determined by controller 14. In some embodiments, the pulse timing, duration, and/or frequency are suitable to reduce dynamic effects of pulsing on the upstream system pressure and flow, thereby creating a controlled variable resistance to flow. In alternative embodiments, valve assembly 24 may be pneumatically or hydraulically actuated.

Each valve assembly 24 is connected in fluid communication between fluid supply line 32 and a corresponding one of the plurality of nozzles assemblies 22 to control fluid flow through the respective nozzle assembly 22. In some embodiments, valve assembly 24 is configured to be mounted to and/or integrated within a portion of spray nozzle 42.

The term “duty cycle,” as used herein, refers to the cycle of operation of a valve assembly 24 operating intermittently rather than continuously and includes the percentage of time that valve assembly 24 is open divided by the total operation time. The duty cycle controls the flow rate or emission rate of material 30 through nozzle assembly 22 in a rapid on/off manner.

In one embodiment, controller 14 is configured to regulate the timing and duration of operation of valve assembly 24, to control the phasing between nozzles assemblies 22 to facilitate reducing harmonics and/or vibrations of manifold 18. For example, the phasing and or timing of nozzle assemblies 22 can be regulated to facilitate reducing and/or eliminating water hammering in fluid supply line 32. The phrase “water hammering” as used herein includes a sudden change in flow of material 30, which can result in shock waves propagating through fluid application system 10. Flow changes can occur due to operation of nozzles assemblies 22, starting and stopping of a pump assembly (e.g., pump assembly 50), and/or directional changes caused by fittings between nozzles assemblies 22 and manifold 18, for example.

In one particular embodiment, valve assembly 24 may be configured the same as or similar to the valves disclosed in U.S. Pat. No. 9,435,458 (the '458 patent), filed on Mar. 2, 2012, and entitled “Electrically Actuated Valve for Control of Instantaneous Pressure Drop and Cyclic Durations of Flow,” which is incorporated by reference herein in its entirety for all purposes. Specifically, the '458 patent discloses a solenoid valve in which the valve poppet is configured to be pulsed such that the cyclic durations of the poppet control the average flow rate through the valve. For example, the valve may be operated with a pulse-width modulation, in which the poppet moves from a sealed position to an open position relative to the valve inlet and/or valve outlet and the duty cycle of the pulse controls the average flow rate. Additionally, the pressure drop across the valve may be controlled during each pulse of the poppet by regulating the position to which the poppet is moved relative to the valve inlet and/or the valve outlet. For instance, the displacement of the poppet may be regulated such that the valve is partially opened during each pulse.

In the example embodiment, nozzle body 41 receives material 30 flowing through fluid supply line 32, and spray nozzle 42 includes a nozzle head attached to and/or formed integrally with nozzle body 41. The nozzle head is configured for emitting material 30 from nozzle assembly 22 onto the crop and/or the ground.

In the illustrated embodiment, valve assemblies 24 are coupled in communication with controller 14. In particular, a respective actuator of each valve assembly 24 is coupled in communication with controller 14. Controller 14 controls one or more operating parameters of each valve assembly 24, for example, and without limitation, a timing, a duration, a duty cycle percentage, and/or a pulse frequency of valve assembly 24. In one embodiment, valve assembly 24 has an operational frequency in the range of between and including about 0 Hertz (Hz) and about 15 Hz, and can have a duty cycle in the range between and including 0% to 100%.

In one particular embodiment, controller 14 may be configured the same as or similar to the controller disclosed in U.S. Pat. No. 8,191,795 (the '795 patent), filed on Jul. 31, 2009, and entitled “Method and System to Control Nozzles While Controlling Overall System Flow and Pressure,” which is incorporated by reference herein in its entirety for all purposes. Specifically, the '795 patent discloses using a “flow factor” for individually scaling fluid flow from each valve assembly 24. For example, the controller is configured to control the rate at which the liquid agricultural product is emitted from each valve based upon the calculated flow factor for each valve.

As described above, in the example embodiment, controller 14 is configured to regulate the overall application rate of material 30 by fluid application system 10 to achieve predetermined flow and pressure objectives while regulating or controlling the individual flow of each individual nozzle assembly 22 to achieve a specific distribution of material 30 across the plurality of nozzle assemblies 22. More particularly, controller 14 is configured to receive various input data, including, for example, and without limitation, flow rate data, a target application rate for material 30 (e.g., gallons per acre), nozzle droplet spectra data, a fluid pressure within fluid supply line 32, and a ground speed at which fluid application system 10 is moving or being moved across a surface. Controller 14 may be configured to receive the target application or flow rate information based on, e.g., a user input target application rate input at a user input device (e.g., user input device 16).

In some embodiments, for example, as the ground speed of spray apparatus 12 increases, controller 14 increases a flow rate of material 30 through fluid application system 10 to maintain the target application rate. Similarly, as the ground speed of spray apparatus 12 decreases, controller 14 decreases a flow rate of material 30 through fluid application system 10 to maintain the target application rate.

Controller 14 is configured to control at least one operating parameter of each of the plurality of valve assemblies 24. For example, controller 14 is configured to control a duty cycle of each valve assembly 24. In alternative embodiments, controller 14 may be configured to control operating parameters of any components of fluid spray apparatus 12.

User input device 16 is communicatively coupled to controller 14 and is configured to send signals to and receive signals from controller 14. In the example, user input device 16 and controller 14 are connected by a wired connection. In some embodiments, user input device 16 and controller 14 may be connected by a wireless connection. In other embodiments, user input device 16 and controller 14 may be connected in any suitable manner. For example, in some embodiments, at least one relay or data storage device may be used to transfer information between controller 14 and user input device 16.

Controller 14 includes at least one processor 70 and at least one memory 72. In the example embodiment, user input device 16 and controller 14 are shown as separate devices. In such embodiments, although not specifically shown, user input device 16 also includes a respective processor and memory. In other embodiments, user input device 16 and controller 14 may be incorporated into a single device. For example, user input device 16 and controller 14 may be included in a computing device mounted to a portion of fluid application system 10.

In the example embodiment, user input device 16 includes a user interface 44. User interface 44 can be configured to present or display information to a user of user input device 16, and to receive user input, for example, relating to operation of fluid application system 10. In some embodiments, user interface 44 includes a presentation interface or display screen (e.g., a light such as a light emitting diode (LED), a monitor, LCD screen, or touch screen) that presents or displays information to a user of user input device 16, and an input device (e.g., a switch, a button, a keyboard, a mouse, or a touch screen) that receives the user input. In some embodiments, such as the illustrated embodiment, the presentation interface includes an indicator 43, and the input device includes switches 45. In other embodiments, the presentation interface and the input device are integrated into a single component, such as a touch screen. In some embodiments, user interface 44 is configured to generate or display a graphical user interface for presenting information to a user and receiving user input. The graphical user interface may be implemented as a downloadable application and/or a website. In such embodiments, users of fluid application system 10 may use their own, individual portable electronic devices (e.g., smartphones or tablets) with fluid application system 10.

In the example embodiment, fluid application system 10 has a first or default operation mode in which controller 14 causes valve assemblies 24 to operate in accordance with a first flow value, and a second or alternative operation mode in which controller 14 causes valve assemblies 24 to operate in accordance with a second flow value. In some embodiments, fluid application system 10 may have three or more different operation modes.

User interface 44 is configured to receive a user input relating to a user selection of an operation mode of fluid application system 10. For example, user interface 44 includes switches 45 that an operator actuates to switch an operating mode of fluid application system 10. Switches 45 are arranged to facilitate the user easily switching between operating modes without the user having to calculate or manually adjust characteristics of fluid application system 10. In some embodiments, such as the illustrated embodiment, switches 45 are positionable between a first position that corresponds to an “OFF” mode of fluid application system 10, a second position that corresponds to an “ON—Flow 1” mode of fluid application system 10, and a third position that corresponds to a “Flow 2” mode of fluid application system 10. Flow of fluid through fluid application system 10 is stopped when the “OFF” mode of fluid application system 10 is selected. Fluid application system 10 operates in the first or default operation mode when the “ON—Flow 1” mode of fluid application system 10 is selected. Fluid application system 10 operates in the second or alternative operation mode when the “Flow 2” mode of fluid application system 10 is selected. In one particular embodiment, a user may actuate one or both of switches 45 during operation of fluid application system 10, to cause fluid application system 10 to switch from the default mode of operation to the alternative operation mode when, for example, there is a gap or variation in the foliage.

In the illustrated embodiment, switches 45 are momentary switches. That is, at least one of the selectable positions of switches 45 will remain active only when the switch 45 is actuated (e.g., pressed, held, etc.) in that position. In the illustrated embodiment, for example, each switch 45 requires a user to actively press or hold the switch 45 in the third position in order for the “Flow 2” mode of fluid application system 10 to remain active. When a user releases the switch 45 after being actuated into the third position, the switch 45 will return to one of the other two selectable positions (e.g., to the position associated with the “ON—Flow 1” mode). In this embodiment, each switch 45 is biased away from the third position towards the second position (e.g., using a spring) such that each switch 45 returns to the second position when the switch 45 is released after being actuated into the third position.

Controller 14 is communicatively connected to user input device 16 and configured to receive signals from user input device 16 corresponding to the user selection of an operation mode. Based on the signals (e.g., in response to user inputs or selections), controller 14 retrieves, for example, a first or second flow value that relates to at least one operating parameter of valve assemblies 24. For example, the first or second values may be included in one or more profiles stored in a memory (e.g., locally on memory 72 or retrieved from a remote memory via a wired or wireless connection). The profiles include respective preset values for operating parameters of valve assemblies 24 (e.g., flow rate, duty cycle, etc.) that are associated with or assigned to each operating mode. Controller 14 operates valve assemblies 24 in accordance with the first or second flow values based on the selected mode. For example, controller 14 operates valve assemblies 24 in accordance with the first flow value when the first operation mode is selected, and operates valve assemblies 24 in accordance with the second flow value when the second operation mode is selected.

For example, controller 14 controls operating parameters of valve assemblies 24 including, for example and without limitation, a desired application rate, an on/off setting of one or more of the electrically actuated valve assemblies 24, a flow distribution of the fluid (e.g., material 30) emitted by the plurality of nozzle assemblies 22, a set point operating pressure of the fluid flowing through fluid application system 10, and emitted set point pressure of the fluid by the plurality of nozzle assemblies 22.

In the example embodiment, valve assemblies 24 are divided into a first group of valve assemblies 24 and a second group of valve assemblies 24. For example, the first group of valve assemblies 24 corresponds to a left portion of the manifold 18 and the second group of valve assemblies 24 corresponds to a right portion of the manifold 18. User input device 16 includes a first switch 45 (e.g., the left switch 45, in the view of FIG. 1) that enables a user to select an operation mode for the first group of valve assemblies 24, and a second switch 45 (e.g., the right switch 45, in the view of FIG. 1) that enables a user to select an operation mode for the second group of valve assemblies 24 independent of the operation mode of the first group of valve assemblies 24.

In some embodiments, the user may provide a first user input relating to a first user selection of an alternative operation mode for the first set of electrically actuated valve assemblies, via the first switch 45. For example, the user may provide the first user input by adjusting a position of the first switch 45. The user may provide a second user input relating to a second user selection of an alternative operation mode for the second set of electrically actuated valve assemblies, via the second switch 45. For example, the user may provide the first user input by adjusting a position of the first switch 45. Controller 14 may operate the groups of valve assemblies 24 in response to the user input. For example, controller 14 operates the first set of valve assemblies 24 in response to user input via the first switch 45, and operates the second set of valve assemblies 24 in response to user input via the second switch 45.

Accordingly, a user is able to independently control the operation mode of the groups of valve assemblies 24 to account for different conditions of the foliage or lack of foliage at positions across valve assemblies 24 (e.g., on the left and right sides of spray apparatus 12 as it travels through a grove or orchard). In other embodiments, valve assemblies 24 are not divided into groups or are divided into more than two groups, each of which may have a corresponding switch associated with operation thereof.

In one example embodiment, fluid application system 10 includes one or more sensors 74. Sensors 74 are configured to sense or measure characteristics of the environment around fluid application system 10 as fluid application system 10 is operating. For example, fluid application system 10 includes visual sensors 74 configured to capture visual data related to area of interest within the environment, such as foliage. Sensors 74 may include any suitable visual sensor, such as a camera (which may generate static image and/or video data), RADAR, or LiDAR sensor, and may measure and output sensor data related to images captured or RADAR/LiDAR responses. In some embodiments, sensors 74 may include one more alternative sensors, such as a sonar/acoustic sensor.

In the example embodiment, controller 14 is configured to receive and process the sensor data to determine visual characteristics of the areas of interest within the environment, including (but not limited to) whether foliage is present in an area of interest, and, if so, whether the foliage has characteristics within a predefined threshold. In some embodiments, the characteristics of the foliage relate to the size and/or density of the foliage within an area of interest. The predefined threshold may include, therefore, a size or density threshold. Controller 14 may be programmed to execute any suitable processing functions on the sensor data to determine the content of the sensor data, including, but not limited to, image processing, signal processing, point cloud classification, feature extraction, and the like.

The sensor data, when processed, may represent a set of conditions that correspond to the operating modes of fluid application system 10: no foliage (fluid application system 10 is “OFF”), standard or large foliage (default operating mode, “ON—FLOW 1”), or small foliage (alternative operating mode, “ON—FLOW 2”).

Controller 14 processes sensor data from sensors 74 and determines a control operation based thereon, specifically a preset operating parameter of valve assemblies 24 according to a stored profile. Based on the sensor data, controller 14 retrieves, for example, a first or second flow value that relates to at least one operating parameter of valve assemblies 24. Controller 14 operates valve assemblies 24 in accordance with the first or second flow values based on the selected mode. Flow of fluid through fluid application system 10 or through select valve assemblies 24 is stopped when the “OFF” mode of fluid application system 10 is selected, when controller 14 determines, from the sensor data, that no foliage is present. Valve assemblies 24 operate in the first or default operation mode when the “ON—Flow 1” mode of fluid application system 10 is selected, when controller 14 determines, from the sensor data, that standard or large foliage is present. Valve assemblies 24 operate in the second or alternative operation mode when the “Flow 2” mode of fluid application system 10 is selected, when controller 14 determines, from the sensor data, that small foliage is present. In an alternative embodiment, the default operating mode may be associated with small foliage, and the alternative operating mode may be associated with large foliage.

In some embodiments, valve assemblies 24 are divided into a first group of valve assemblies 24 and a second group of valve assemblies 24. For example, the first group of valve assemblies 24 corresponds to a left portion of manifold 18 and the second group of valve assemblies 24 corresponds to a right portion of manifold 18. Fluid application system 10 includes a first set of sensors 74 and a second set of sensors 74. The first set of sensors 74 are oriented and programmed to capture data related to areas of interest on the left side of manifold 18, and the second set of sensors 74 are oriented and programmed to capture data related to areas of interest on the right side of manifold 18. The first and second sets of sensors 74 may respectively include two sensors 74, as shown in FIG. 1. Alternatively, the first and second sets of sensors 74 may respectively include a single sensor 74 or more than two sensors 74.

Controller 14 receives and interprets first sensor data from the first set of sensors 74 to select an operating mode for the first group of valve assemblies 24, and controller 14 receives and interprets second sensor data from the second set of sensors 74 to select an operating mode for the second group of valve assemblies 24, independent of the operation mode of the first group of valve assemblies 24.

Accordingly, controller 14 is configured to automate switching of the operating mode of valve assemblies 24 in response to sensor data, where the parameters of the operating mode are preset within stored user profiles. As described herein, these profiles may include operating parameters for valve assemblies 24 in each operating mode, and profiles may further include thresholds or other definitions according to which controller 14 interprets the sensor data from sensors 74.

Fluid application system 10 includes a global positioning system (GPS) receiver 60 communicatively connected to controller 14. GPS receiver 60 is configured to receive a GPS signal from at least one GPS satellite (not shown). For example, the GPS signal is in National Marine Electronics Association (NMEA) format and includes data such as a time stamp, latitude information, longitude information, quality indicator, satellite information, altitude information, units information, geoidal separation, and speed information. In the example embodiment, controller 14 or GPS receiver 60 filters the GPS signal(s) to identify and extract speed information (e.g., a speed component). Controller 14 determines a ground speed of fluid application system 10 based on a speed component of the GPS signal. If multiple GPS signals are available, controller 14 selects the most reliable or precise speed component or averages the speed components to calculate the ground speed of fluid application system 10. Further, in the example embodiment, controller 14 is configured to sample a plurality of the GPS signals over time, and calculate a moving average speed based on the speed components of the plurality of GPS signals.

Controller 14 or GPS receiver 60 is configured to receive and verify one or more GPS signals and extract speed component(s) from each GPS signal. After extraction, controller 14 is configured to compare a speed value for each speed component of the one or more GPS signals to a range of acceptable values and disregard any speed value if that speed value is outside the range of acceptable values. Controller 14 is configured to determine at least one operating parameter of valve assemblies 24 based on the valid speed value(s) determined from the speed component(s).

During operation, for example, GPS receiver 60 receives a GPS signal at regular intervals such as one signal per second when GPS receiver 60 is active. In the example embodiment, GPS receiver 60 transmits the GPS signal to controller 14, and controller 14 checks that the GPS signal is complete (e.g., includes a speed component). If the GPS signal is complete, controller 14 runs a parsing process for the signal, in which controller 14 identifies a type of NMEA message format used for the GPS signal and confirms that the GPS signal includes a valid message. Controller 14 extracts and converts a speed value from the GPS signal if the GPS signal includes a speed component. Controller 14 compares the speed value to a predetermined range of acceptable speed values. For example, a predetermined range of acceptable speed values is 1 to 5 miles per hour (mph) in some embodiments. The predetermined range is much slower than other fluid application systems because fluid application systems used for applying fluid in groves or orchards, for example, travel at much slower rates of speed than in other applications.

Controller 14 records the speed value as an erroneous reading if the speed value is outside the predetermined range (or, in some embodiments, disregards or does not record the erroneous speed value). Controller 14 records the speed value as a valid value if the speed value is within the predetermined range. Controller 14 calculates a moving average based on the speed value and any previously recorded valid speed values. This moving average represents a ground speed of fluid application system 10. Controller 14 then clears a message buffer and waits for a subsequent GPS signal.

Controller 14 is configured to operate fluid application system 10 based on the determined ground speed. For example, controller 14 is configured to determine at least one operating parameter of valve assemblies 24 based on the determined ground speed if the ground speed of the system is within the predetermined range of acceptable values.

In addition, in contrast to other systems, fluid application system 10 does not stop spray out of nozzle assemblies 22 if fluid application system 10 travels at a slower speed, fluid application system 10 is stopped, or speed information is unavailable. In the example embodiment, controller 14 is configured to retrieve a preset value and determine the at least one operating parameter of the plurality of electrically actuated valve assemblies 24 based on the preset value, if the ground speed of fluid application system 10 is outside the predetermined range of acceptable values. The preset value is a standard speed value for applying fluid to groves or orchards, e.g., 1 mph, 2 mph, 3 mph, or 4 mph, and is stored in the memory (e.g., memory 72). Fluid application system 10 defaults to the preset value to facilitate continued operation of fluid application system 10 when GPS information is unavailable for example due to interference of the foliage and/or if fluid application system 10 is not moving at a detectable speed. When fluid application system 10 is stopped, the user may manually turn off the system by, for example, by moving the switches 45 to the “OFF” position.

User input device 16 includes a bypass system 64 configured to cause controller 14 to disregard the GPS signal and determine the at least one operating parameter of valve assemblies 24 based on a preset value. For example, the preset value is a stored value or is input by the user via, for example, user interface 44. In the example embodiment, bypass system 64 includes a switch 66 that is positioned between a first position such as a “PULSE Flow 1 & 2” position and a second position such as a “BYPASS 100% Duty Cycle”. The user moves switch 66 to select the first or second position. When switch 66 is in the first position, controller 14 operates valve assemblies 24 to pulse, based on the user selected operating modes (e.g., identified by the position of switches 45) and the GPS information. When switch 66 is in the second or bypass position, controller 14 disregards the position of switches 45 and the GPS information. In the example embodiment, valve assemblies 24 are operated at 100% duty cycle (e. g., fully on) when switch 66 is in the bypass position. Accordingly, bypass system 64 facilitates operation of fluid application system 10 without physically modifying the setup of fluid application system 10 if, for example, there is an error or malfunction with some components of fluid application system 10 or if the user desires to operate without pulsing operation of valve assemblies 24.

During operation, controller 14 sets up and decrements “counters” or “counter values” to determine a pulse or shot duration for each valve assembly 24. For example, controller 14 retrieves one or more base counter values from the memory (e.g., memory 72) based on an active or selected user profile. For example, controller 14 determines if the default or alternative operation mode is selected by the user, and sets an initial “on-time” counter to a first value stored for the default operation mode, or to a second value stored for the alternative operation mode. Controller 14 also sets an initial “off-time” counter to a first value stored for the default operation mode, or to a second value stored for the alternative operation mode. The sum of the on-and off-time counter values add up to a complete “pulse”, or pulse duration, which is 100 milliseconds (ms) in the example embodiment. Controller 14 adjusts the initial on-time and off-time counter values to compensate for the actual speed at which fluid application system 10 is traveling when the GPS receiver 60 is active.

Decrementing the counter values refers to the process of electronically setting the valve assemblies 24 to open or closed based on the current on/off counter value, and then decrementing the counter value by 1. In the example embodiment, controller 14 initially starts decrementing the on-time counter value (i.e., setting the associated valve assembly 24 to the open position), and then the off-time counter value (i.e., setting the associated valve assembly 24 to the closed position). When both counters are finished (i.e., are decremented to zero), the process repeats, and the controller 14 initializes and adjusts the counter values for the next pulse. This process runs continuously while fluid application system 10 is operating (i.e., applying fluid). In the example embodiment, controller 14 decrements the counter values every 1 ms. Additionally, In the example embodiment, controller 14 calculates the adjusted on-time value once every 100 ms for each valve assembly 24 associated with a respective nozzle assembly 22.

For example, controller 14 determines if GPS receiver 60 is active and if the bypass mode is selected and determines an adjustment to the on-time value if the GPS receiver 60 is active and the bypass mode is not selected. To determine the adjustment, controller 14 calculates a difference between a user profile target speed and a moving speed average determined using the GPS signal. Controller 14 divides the difference by the user profile target speed to calculate a percentage off target. Controllers 14 multiplies the percentage off target and the initial on-time value to calculate an adjusted on-time value for each valve assembly 24.

Controller 14 compares the adjusted on-time value to a predetermined range and disregards the adjusted on-time value if the adjusted on-time value is outside the predetermined range. Controller 14 operates the respective valve assembly 24 in accordance with the initial on-time value, a preset minimum value, or a preset maximum value if the adjusted on-time value is outside the predetermined range. If the adjusted on-time value is within the predetermined range, controller 14 operates the respective valve assembly 24 in accordance with the adjusted on-time value. Controller 14 determines an off-time by subtracting the adjusted on-time value (or the one of the initial on-time value, the preset minimum value, or the preset maximum value) from a full shot time (e.g., 100 ms).

User interface 44 includes an indicator 43 configured to provide an indication if controller 14 is controlling the operating parameter of valve assemblies 24 based on the determined ground speed or the preset value. For example, indicator 43 includes a light that is illuminated a first color (e.g., green) to indicate normal operation (e.g., fluid application system 10 is traveling at a speed within the predetermined range and the GPS signal is able to be used to determine the ground speed). The light is intermittently illuminated (e.g., flashes) a second color (e.g., blue) to indicate that fluid application system 10 is traveling at a speed outside of the predetermined range or at the extents of control based on the determined ground speed. The light is illuminated with a third color (e.g., red) to indicate that fluid application system 10 is unable to be operated using the ground speed determined based on the GPS signal (e.g., because the GPS signal has been lost).

Although certain functions,

determinations, and/or calculations are described herein as being performed by one of controller 14, user input device 16, and GPS receiver 60, it should be understood that such functions, determinations, and/or calculations may be performed by controller 14, user input device 16, or GPS receiver 60, and further, that such functions, determinations, and/or calculations may be distributed among controller 14, user input device 16, or GPS receiver 60. By way of example, controller 14, user input device 16, and/or GPS receiver 60 may form or be incorporated into a control system 68 that controls spray apparatus 12 in accordance with the control algorithms and methods described herein. The functions, determinations, and/or calculations described herein as being performed by one of controller 14, user input device 16, and GPS receiver 60, can be distributed across components of control system 68 in any suitable manner that enables fluid application system to function as described herein.

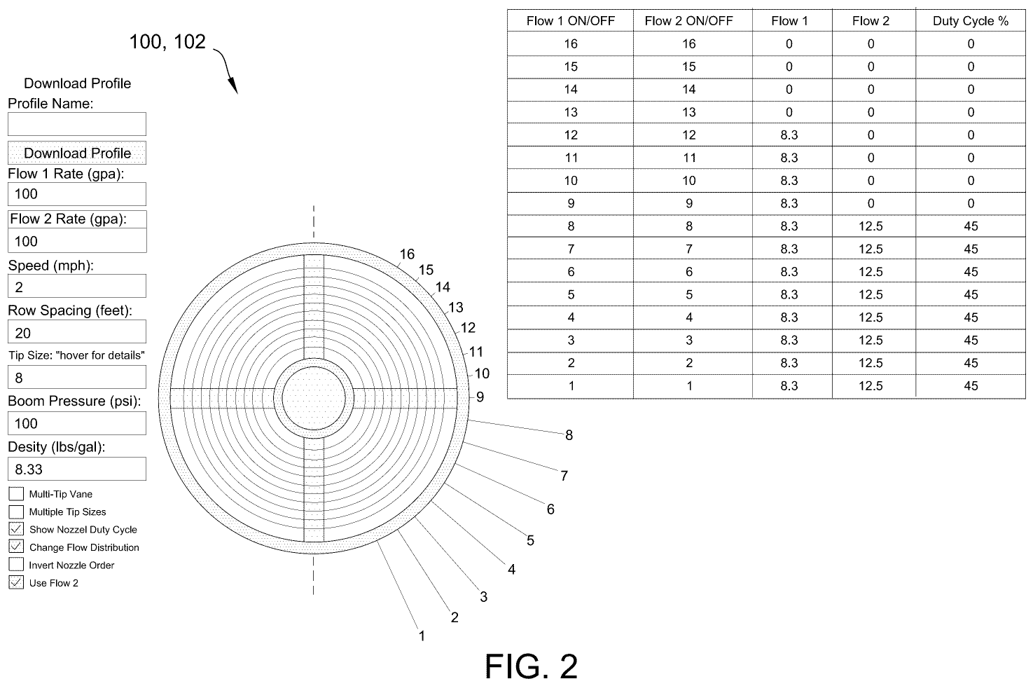

FIG. 2 is an image of an example graphical user interface 100 that may be displayed on a user interface of, for example, a portable electronic device (not shown). Graphical user interface 100 may include a series of windows or screens 102 that allow a user to receive and input information. Graphical user interface 100 may be hosted on a website (e.g., either locally on controller 14 or accessible via the Internet) that allows a user to access graphical user interface 100 using any computing device that is connected to the Internet and/or controller 14. In other embodiments, graphical user interface 100 may be at least partially stored (e.g., as computer executable instructions or software) on a computing device.

In the example embodiment, graphical user interface 100 allows a user to input values corresponding a profile for fluid application system 10. For example, window 102 includes a plurality of input fields that allows a user to input physical characteristics of fluid application system 10 such as, without limitation, a first desired flow rate for a “Flow 1” operation mode, a second desired flow rate for a “Flow 2” operation mode, a target speed of fluid application system 10, a row spacing, a size of nozzle assemblies 22, a pressure of fluid in a boom (e.g., manifold 18), and a fluid density (e.g., of material 30). In other embodiments, user interface 100 may receive any user input that allows fluid application system 10 to operate as described herein. For example, user interface 100 may include inputs for a specific gravity of material 30 to be applied, a size of valve assemblies 24, and a dimension of manifold 18 (“diameter of sprayer”).

In some embodiments, graphical user interface 100 may allow a user to store and load a profile that includes pre-stored physical characteristics of a spray apparatus, and allow users to repeatedly use the same settings without reentering the values. In addition, graphical user interface 100 may include a default profile. For example, a user may download two or more profiles and switch between the profiles using user input device 16. In some embodiments, “Flow 1” and “Flow 2” values are included in separate profiles. In other embodiments, graphical user interface 100 may include any suitable profiles.

FIG. 2 illustrates window 102 with the input fields populated with example values. For example, the profile may be a default profile. The profile has the following pre-stored values populated in the input fields of window 102:

Flow 1 Rate (gpa): 100
Flow 2 Rate (gpa): 100
Speed (mph): 2
Row Spacing (feet): 20

### Tip Size: 8

Boom Pressure (psi): 8
Density (lbs./gallon): 8.33

In addition, window 102 includes user selected options that may be selected or unselected. The options include, for example and without limitation, “Multi-tip Vane”, “Multiple Tip Sizes”, “Show Nozzle Duty Cycle”, “Change Flow Distribution”, “Invert Nozzle Order”, and “Use Flow 2”. Window 102 also includes fields that display operating parameters for each active nozzle assembly such as “Flow 1 ON/OFF”, “Flow 2 ON/OFF”, “Flow 1”, “Flow 2”, and “Duty Cycle”.

In response to the user input, based on the information input via graphical user interface 100, controller 14 (shown in FIG. 1) and/or user input device 16 (shown in FIG. 1) determines operating parameters of fluid application system 10 (shown in FIG. 1), such as an operating duty cycle for each valve assembly 24 (shown in FIG. 1). In some embodiments, the operating values are sent to controller 14 (shown in FIG. 1), and controller 14 operates fluid application system 10 based on the determined values. In other embodiments, the user adjusts nozzle assemblies 22 (shown in FIG. 1) and/or valve assemblies 24 based on the values determined by user input device 16.

User interface 100 may provide diagnostic information based on the input values and/or the determined operating parameters. For example, window 102 includes diagnostic fields that display the duty cycle for each nozzle assembly 22 of fluid application system 10. In other embodiments, user interface 100 may provide any outputs that allow fluid application system 10 to operate as described herein.

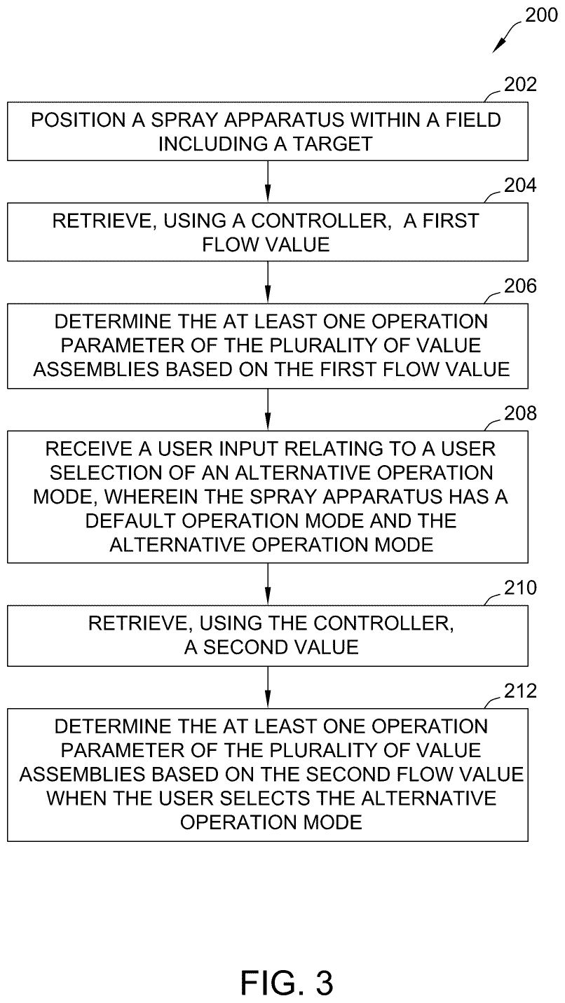

FIG. 3 is a flow diagram of an example method 200 of applying agricultural fluid to foliage. With reference to FIGS. 1 and 3, method 200 includes positioning 202 spray apparatus 12 within a field including foliage and retrieving 204, using controller 14, a first flow value that relates to at least one operating parameter of valve assemblies 24. Method 200 includes determining 206 the at least one operating parameter of valve assemblies 24 based on the first flow value. In some embodiments, controller 14 operates valve assemblies 24 in accordance with the first flow value in response to a user selecting the default operating mode using user input device 16.

Method 200 includes receiving 208 a user input relating to a user selection of an alternative operation mode, and retrieving 210, using controller 14, a second flow value that relates to the at least one operating parameter of the plurality of electrically actuated valve assemblies. For example, the user positions switch 45 of user input device 16 to the third position to select the alternative operation mode that corresponds to the second flow value.

Method 200 includes determining 212 the at least one operating parameter of valve assemblies 24 based on the second flow value in response to the user selecting the alternative operation mode. For example, in some embodiments, controller 14 individually actuates the plurality of valve assemblies 24 to obtain a desired flow characteristic of fluid emitted from each nozzle assembly 22 based on the second profile. The operating parameter may be any suitable operating parameter including, for example and without limitation, a duty cycle of each valve assembly 24.

Method 200 may include additional, fewer, or alternative actions, including those described elsewhere herein.

In some embodiments, user interface 44 includes at least one switch 45, and receiving 208 includes receiving the user input in response to the user adjusting a position of the mechanical switch.

In some embodiments, the plurality of electrically actuated valve assemblies 24 includes the first set of electrically actuated valve assemblies 24 and the second set of electrically actuated valve assemblies 24, and the user input is a first user input relating to a first user selection of an alternative operation mode for the first set of electrically actuated valve assemblies 24. User interface 44 is configured to receive (e.g., receiving 208) a second user input relating to a second user selection of an alternative operation mode for the second set of electrically actuated valve assemblies 24. Method 200 may further include operating the first set of electrically actuated valve assemblies 24 in accordance with the second flow value in response to the first user input, and operating the second set of electrically actuated valve assemblies 24 in accordance with the second flow value in response to the second user input.

In some such embodiments, user interface 44 includes a first switch 45 and a second switch 45, and method 200 further includes receiving 208 the first user input in response to the user adjusting a position of the first switch 45, and receiving 208 the second user input in response to the user adjusting a position of the second switch 45.

While, in some embodiments, the described methods and systems are used to handle a fluid that is applied to agricultural fields, such as an herbicide or a pesticide, the described methods and systems may be used for handling any type of fluids, not just fluids for use in the agricultural industry.

Embodiments of the methods and systems described herein may more efficiently apply materials, such as fluids, to surfaces compared to prior methods and systems. For example, the systems and methods described provide improved fluid application systems that increase the precision and operating efficiency of foliage spray systems. In addition, the methods and systems reduce the time required to adjust operating parameters, such as duty cycle, based on variations or gaps in foliage.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

When introducing elements of the present invention or the preferred embodiment(s) thereof, the articles “a”, “an”, “the” and “the” are intended to mean that there are one or more of the elements. The terms “comprising”, “including” and “having” are intended to be inclusive and mean that there may be additional elements other than the listed elements. Moreover, the use of “top”, “bottom”, “above”, “below” and variations of these terms is made for convenience, and does not require any particular orientation of the components.

As various changes could be made in the above without departing from the scope of the invention, it is intended that all matter contained in the above description and shown in the accompanying drawings shall be interpreted as illustrative and not in a limiting sense.

What is claimed is:

1. A system for applying agricultural fluid to a target, the system comprising:
a fluid supply line connected to a fluid supply;
a plurality of nozzle assemblies connected in fluid communication with the fluid supply line, the nozzle assemblies being positioned and oriented to spray the target;
a plurality of electrically actuated valve assemblies, each valve assembly of the plurality of electrically actuated valve assemblies connected in fluid communication between the fluid supply line and a corresponding one of the plurality of nozzle assemblies to control fluid flow through the respective nozzle assembly;
a user interface configured to receive a user input relating to a user selection of an alternative operation mode of the system; and
a controller communicatively connected to the valve assemblies and configured to control at least one operating parameter of the plurality of electrically actuated valve assemblies, wherein the controller is configured to:
retrieve a first flow value;
determine the at least one operating parameter based on the first flow value;
receive a signal from the user interface relating to the user selection of the alternative operation mode;
retrieve a second flow value; and
determine the at least one operating parameter based on the second flow value in response to the user selecting the alternative operation mode.

2. The system of claim 1, wherein the plurality of electrically actuated valve assemblies includes a first set of electrically actuated valve assemblies and a second set of electrically actuated valve assemblies, wherein the user input is a first user input relating to a first user selection of an alternative operation mode for the first set of electrically actuated valve assemblies, and wherein the user interface is configured to receive a second user input relating to a second user selection of an alternative operation mode for the second set of electrically actuated valve assemblies.

3. The system of claim 2, wherein the controller is configured to operate the first set of electrically actuated valve assemblies in accordance with the second flow value in response to the first user input, and operate the second set of electrically actuated valve assemblies in accordance with the second flow value in response to the second user input.

4. The system of claim 2, wherein the user interface comprises a first switch and a second switch, wherein the first user input is based on the user adjusting a position of the first switch and the second user input is based on the user adjusting a position of the second switch.

5. The system of claim 1, further comprising a portable electronic device that is configured to store a new user profile in a memory based on a user input, wherein the new user profile includes the second flow value, and wherein the controller is configured to retrieve the new user profile in response to the user selection of the alternative operation mode.

6. The system of claim 1, wherein the at least one operating parameter of the plurality of electrically actuated valve assemblies includes at least one of the following: a desired application rate, an on/off setting of one or more of the electrically actuated valve assemblies, a flow distribution of the fluid emitted by the plurality of nozzle assemblies, a set point operating pressure of the fluid flowing through the system, and emitted set point pressure of the fluid by the plurality of nozzle assemblies.

7. The system of claim 1, wherein the plurality of electrically actuated valve assemblies comprise direct acting solenoid valves, each solenoid valve including an actuator configured to pulse with a timing, a duration, a frequency, and a duty cycle determined by the controller.

8. The system of claim 1, wherein the user interface comprises at least one switch, wherein the user interface is configured to receive the user input in response to the user adjusting a position of the at least one switch.

9. A method of applying agricultural fluid to a target, the method comprising:
positioning a spray apparatus within a field including the target, the spray apparatus including:
a fluid supply line;
a plurality of nozzle assemblies connected in fluid communication with the fluid supply line, the nozzle assemblies being positioned and oriented to spray the target; and
a plurality of electrically actuated valve assemblies, each valve assembly of the plurality of electrically actuated valve assemblies connected in fluid communication between the fluid supply line and a corresponding one of the plurality of nozzle assemblies to control fluid flow through the respective nozzle assembly, wherein a controller is communicatively connected to the valve assemblies and configured to control at least one operating parameter of the plurality of electrically actuated valve assemblies;
retrieving, using the controller, a first flow value;
determining the at least one operating parameter of the plurality of valve assemblies based on the first flow value;
receiving a user input relating to a user selection of an alternative operation mode of the system;
retrieving, using the controller, a second flow value; and
determining the at least one operating parameter of the plurality of valve assemblies based on the second flow value in response to the user selecting the alternative operation mode.

10. The method of claim 9, wherein the plurality of electrically actuated valve assemblies includes a first set of electrically actuated valve assemblies and a second set of electrically actuated valve assemblies, wherein the user input is a first user input relating to a first user selection of an alternative operation mode for the first set of electrically actuated valve assemblies, and wherein the user interface is configured to receive a second user input relating to a second user selection of an alternative operation mode for the second set of electrically actuated valve assemblies, the method further comprising:
operating the first set of electrically actuated valve assemblies in accordance with the second flow value in response to the first user input; and
operating the second set of electrically actuated valve assemblies in accordance with the second flow value in response to the second user input.

11. The method of claim 10, wherein the user interface includes a first switch and a second switch, the method further comprising:
receiving the first user input in response to the user adjusting a position of the first switch; and
receiving the second user input in response to the user adjusting a position of the second switch.

12. The method of claim 9, wherein the user interface includes at least one switch, and wherein receiving the user input comprises receiving the user input in response to the user adjusting a position of the switch.

13. A system for applying agricultural fluid to a target as the system moves relative to the target, the system comprising:
a fluid supply line connected to a fluid supply;
a plurality of nozzle assemblies connected in fluid communication with the fluid supply line, the nozzle assemblies being positioned and oriented to spray the target;
a plurality of electrically actuated valve assemblies, each valve assembly of the plurality of electrically actuated valve assemblies connected in fluid communication between the fluid supply line and a corresponding one of the plurality of nozzle assemblies to control fluid flow through the respective nozzle assembly;
a global positioning system (GPS) receiver configured to receive a GPS signal from at least one GPS satellite, wherein the GPS signal includes a speed component relating to a speed of the system; and
a controller communicatively connected to the plurality of electrically actuated valve assemblies and the GPS receiver, the controller configured to control at least one operating parameter of the plurality of electrically actuated valve assemblies, wherein the controller is configured to:
filter the GPS signal to identify the speed component;
determine a ground speed of the system based on the speed component of the GPS signal;
determine the at least one operating parameter of the plurality of electrically actuated valve assemblies based on the determined ground speed if the determined ground speed of the system is within a predetermined range; and
determine the at least one operating parameter of the plurality of electrically actuated valve assemblies based on a preset value if the determined ground speed of the system is outside the predetermined range.

14. The system of claim 13, wherein the predetermined range is 1 to 5 miles per hour (mph).

15. The system of claim 13, further comprising a user interface including an indicator configured to provide an indication of whether the controller is controlling the at least one operating parameter of the plurality of electrically actuated valve assemblies based on the determined ground speed or the preset value.

16. The system of claim 13, further comprising a bypass system configured to cause the controller to disregard the GPS signal and determine the at least one operating parameter of the plurality of electrically actuated valve assemblies based on the preset value in response to a user selection of a bypass mode.

17. The system of claim 13, wherein the GPS receiver is configured to sample a plurality of the GPS signals, and wherein the controller is configured to:
filter the plurality of GPS signals to identify the respective speed component of each GPS signal of the plurality of GPS signals;
determine the ground speed of the system as a moving average speed based on the speed components of the plurality of GPS signals.

18. The system of claim 17, wherein the controller is configured to:
compare each speed component of the plurality of GPS signals to a range of acceptable values; and
disregard any speed component that is outside the range of acceptable values.

19. The system of claim 13, wherein the controller is configured to control the at least one operating parameter of the plurality of electrically actuated valve assemblies to increase a flow rate of the fluid through the plurality of nozzle assemblies in response to an increase in the determined ground speed of the system.

20. The system of claim 13, wherein the controller is configured to control the at least one operating parameter of the plurality of electrically actuated valve assemblies to decrease a flow rate of the fluid through the plurality of nozzle assemblies in response to a decrease in the determined ground speed of the system.

21. A system for applying agricultural fluid to a target, the system comprising:
a fluid supply line connected to a fluid supply;
a plurality of nozzle assemblies connected in fluid communication with the fluid supply line, the nozzle assemblies being positioned and oriented to spray the target;
a plurality of electrically actuated valve assemblies, each valve assembly of the plurality of electrically actuated valve assemblies connected in fluid communication between the fluid supply line and a corresponding one of the plurality of nozzle assemblies to control fluid flow through the respective nozzle assembly;
one or more sensors; and
a controller communicatively connected to the one or more sensors and the valve assemblies and configured to control at least one operating parameter of the plurality of electrically actuated valve assemblies, wherein the controller is configured to:
retrieve a first flow value and a second flow value;
determine the at least one operating parameter based on the first flow value;
receive a signal from the one or more sensors related to the alternative operation mode;
select the alternative operation mode based on the signal; and
determine the at least one operating parameter based on the second flow value.
